(19) United States
(12) Patent Application Publication
(10) Pub. No.: US 2018/0195437 A1
(43) Pub. Date: Jul. 12, 2018

(54) TURBOMACHINE AIR STARTER COMPRISING FIRST AND SECOND LUBRICATION COMPARTMENTS

(71) Applicant: MICROTURBO, Toulouse (FR)

(72) Inventors: Remi STEPHAN, Verfeil (FR); Pierre Charles MOUTON, Grigny (FR)

(73) Assignee: MICROTURBO, Toulouse (FR)

(21) Appl. No.: 15/107,002

(22) PCT Filed: Dec. 19, 2014
(86) PCT No.: PCT/FR2014/053462

§ 371 Date: Jun. 21, 2016

(30) Foreign Application Priority Data
Dec. 23, 2013 (FR) 13 63449

(51) Int. Cl. F02C 7/06; F02C 7/277; F02C 7/32

(52) U.S. Cl. CPC F02C 7/06; F02C 7/277; F05D 2220/323; F05D 2260/98; F02C 7/32

(57) ABSTRACT

A turbomachine air starter, including a first compartment wherein non-overrunning elements of the air starter are situated, corresponding to elements which are only run in the turbomachine starting phase, and a second compartment wherein overrunning elements of the air starter are situated, corresponding to the elements which are run throughout an operating time of the turbomachine, including the starting phase. The first compartment includes an oil receptacle for oil splash lubrication of the non-overrunning elements, and the second compartment includes an AWC type oil cavity for lubrication of the overrunning elements supplied by the lubrication oil return of the overrunning elements, in turn supplied with pressurized lubrication oil supplied by the turbomachine, the receptacle and the cavity being internal to the air starter.

### FIELD OF THE INVENTION

The present invention relates to the field of turbomachines, and more particularly to the general field of lubrication of an air starter mounted on a gear box for transmitting power from the starter to the engine.

The invention applies to all types of terrestrial or aeronautical turbomachines, and notably to aircraft turbomachines such as turbojets and turboprops.

It relates more specifically to a turbomachine air starter comprising first and second lubrication compartments, a turbomachine comprising such an air starter, and a method for lubrication of such a starter with oil.

### STATE OF THE RELATED ART

In the general field of turbomachines, an air starter (also known as ATS for “Air Turbine Starter”) is a machine used to start a turbine engine, for example an aircraft engine. The air starter is generally mounted on a power transmission gear box (also known as AGB box for “Accessory Gear Box”) which transmits power from the air starter to the engine.

The U.S. Pat. No. 4,779,413 A and the patent application FR 2 911 916 A1 describe examples of air starters used in gas turbine engines.

An air starter generally comprises a turbine, a reduction gear, a free wheel and a connecting shaft, the whole being borne by bearings.

During starting, the turbine is supplied with compressed air and converts the pneumatic energy to mechanical energy intended to run the engine. The reduction gear consists of gears converting the high rotational speed of the turbine to a lower speed, suitable for running the engine.

Moreover, the free wheel allows the running of the engine by the turbine and the reduction gear and enables, at the same time, the turbine and the reduction gear not to be run by the engine.

Once the engine has started, the starter air supply is shut down such that the turbine and the reduction gear are shut down. The connecting shaft between the air starter and the engine continues to run, however, driven by the engine.

The connecting shaft, the free wheel and the bearings associated therewith form parts of the air starter which run for as long as the engine is running, therefore in particular during the flight of an aircraft. This part is referred to as the “driven part” (or preferentially hereinafter referred to as the “overrunning part”).

On the other hand, the turbine, the reduction gear and the bearings associated therewith form parts of the air starter which only run during the engine starting time. This part is referred to as the “non-driven part” (or preferentially hereinafter referred to as the “non-overrunning part”).

Moreover, in order to be able to function, the air starter, and more particularly the “overrunning” part of the air starter, requires lubrication.

For a very long time, air starters were lubricated by oil splash lubrication using an oil bath independent of the engine oil circuit and were equipped with a ratchet clutch. This solution was however not entirely satisfactory for two main reasons: on one hand, there was a risk of unreported oil leakage liable to result in the destruction of the air starter; on the other, there was poor tolerance of the free wheel in the so-called “running engagement” phases and systematic destruction in the so-called “crash engagement” phases.

Solutions were then envisaged to correct these two main drawbacks independently of one another.

On one hand, it was proposed to associate the air starter oil bath with the engine oil circuit, while protecting the engine from the contamination liable to generated by the air starter. This solution is commonly known as AWC, or “Assisted Wet Cavity”, and described in the U.S. Pat. No. 4,779,413 A. The AWC cavity is an intermediate cavity between the air starter and the engine, supplied with engine oil, which provides additional oil to the air starter in the event of leakage therefrom.

On the other, it was proposed to use a so-called “roller” clutch to render the air starter insensitive to the “running engagement” and “crash engagement” phases. This solution notably required pressurised lubrication of the free wheel.

FIG. 1 illustrates schematically an example of an embodiment of a lubrication circuit of an air starter 10, defined notably on the basis of the solutions described above.

The air starter 10 is mounted on the accessory gear box or AGB 20. The connecting shaft 11 of the air starter 10 with the continuously running components of the clutch is supported in the casing of the air starter 10 by a bearing 12.

The lubrication oil H of the air starter 10 is contained in an internal receptacle 13 to enable the lubrication of the air starter 10. For this purpose, the air starter 10 incorporates an internal oil pump 14 which provides the lubrication of the “overrunning” part of the air starter 10, as shown.

Moreover, the lubrication oil circuit illustrated in FIG. 1 further comprises an AWC type cavity 15, external to the air starter 10, which is supplied with engine oil Hm to provide additional oil to the air starter 10 in the event of leakage therefrom. As such, the receptacle 13 communicates with the AWC cavity 15 via an opening 16, formed in the wall 17 of the casing of the air starter 10.

The opening 16 is protected by a strainer to protect the engine from contamination liable to be generated by the air starter 10. Furthermore, the oil level of the AWC cavity 15, and thus of the receptacle 13, is defined by a spout 18 which allows a return R of oil to the engine oil recovery circuit. Moreover, the equilibration of the pressures between the cavity of the air starter 10 and the cavity of the AGB box 20 is carried out by an opening 19 formed in the upper part of the wall 17 of the casing of the air starter 10.

Using this communicating vessel principle, the monitoring of the oil level H of the air starter 10 is associated with the real-time monitoring of the engine oil circuit. It is also possible to prevent both the choking of the air starter 10 and the risk of contamination of the engine with oil H from the air starter 10.

Nevertheless, while this solution described above has made it possible to solve the problems in respect of leakage and engagement of the free wheel, it has a number of drawbacks detailed hereinafter.

Firstly, the elements of the air starter lubricated under pressure are lubricated using a small quantity of oil contained in a small-volume tank 13, which is not replenished and the quality whereof can be degraded. However, on one hand, the reduction gear of the air starter consisting of gears, potentially generating pollution due to metal/metal friction between the gear teeth in operation which release particles, the oil bath supplying the internal oil pump, and thus the element lubricated under pressure, are exposed to pollution liable to arise from the reduction gear. On the other, the temperature of this oil is not monitored and is not regulated, and the small volume thereof, recirculating continually in the pump in a quasi-closed circuit, exposes same to potentially detrimental overheating.

Secondly, the use of an internal oil pump in the air starter increases the cost and the mass of the air starter, and further represents a potential source of non-reliability as a failure of the pump is not monitored and may give rise to the destruction of the air starter due to a lack of lubrication.

Thirdly, the air starter is liable to be drained rapidly of the oil thereof when the aircraft adopts an extreme attitude, for example in the case where the bottom of the receptacle 13 is raised with respect to the level of the spout 18. In this case, maintaining a sufficient volume of oil in the receptacle 13 to supply the pump 14 is problematic, said pump no longer being supplied and the lubrication of the “overrunning” part 12 of the air starter is no longer ensured.

### DESCRIPTION OF THE INVENTION

The aim of the invention is thus that of remedying at least partially the requirements mentioned above and the drawbacks relating to the embodiments of the prior art.

The invention thus relates, according to one of the aspects thereof, to a turbomachine air starter, characterised in that it comprises:
a first compartment wherein the so-called “non-overrunning” elements of the air starter are situated, corresponding to the elements which are only run in the turbomachine starting phase,
a second compartment wherein the so-called “overrunning” elements of the air starter are situated, corresponding to the elements which are run throughout the operating time of the turbomachine, including the starting phase,

the first compartment comprising an oil receptacle for oil splash lubrication of the “non-overrunning” elements, and the second compartment comprising an AWC type oil cavity for lubrication of the “overrunning” elements supplied by the lubrication oil return of the “overrunning” elements, in turn supplied with pressurised lubrication oil supplied by the turbomachine, the receptacle and the cavity being internal to the air starter.

By means of the invention, it may be possible to obtain optimal lubrication of the sensitive components of an air starter, in particular the components of the “overrunning” part required to provide very considerable running times (as much as the engine). Indeed, the lubrication oil can be supplied regardless of the external conditions (temperature, altitude, attitude, among others). Furthermore, while the solutions according to the prior art using an oil pump require, in extreme attitudes, that a sufficient internal oil level be maintained in the air starter, which is difficult to carry out, the principle according to the invention can make it possible to ensure the satisfactory lubrication of the “overrunning” elements regardless of the attitude. In this respect, it should be noted that the “non-overrunning” elements of the air starter do not need to be lubricated in the case of attitude adoption as they have been shut down given that the engine is already started. Moreover, the oil temperature can be controlled by the engine lubrication system. The lubrication oil can also be clean, continuously replenished and filtered by the engine.

Moreover, the invention can make it possible to retain the advantages associated with the AWC principle, and in particular contain any pollution generated by the reduction gear of the air starter, and thus not contaminate the AGB. Indeed, the “overrunning” elements, which remain supplied under pressure by the engine oil circuit, generate no or practically no pollution.

Finally, the withdrawal of the internal oil pump in the air starter in the solution according to the present invention can make it possible to reduce the cost, mass and also increase the reliability of the air starter.

The air starter according to the invention can further comprising one or a plurality of the following features taken in isolation or according to any possible technical combinations.

The air starter preferentially comprises a turbine, a reduction gear, a free clutch wheel and a connecting shaft, the whole being borne by bearings.

The “overrunning” elements of the air starter comprise the connecting shaft, the free wheel and the bearings associated therewith.

The “non-overrunning” elements of the air starter comprise the turbine, the reduction gear and the bearings associated therewith.

The lubrication oil receptacle for the oil splash lubrication of the first compartment can advantageously communicate with the AWC type cavity of the second compartment via a first opening enabling the equilibration of the oil levels between the receptacle and the cavity.

This first opening can notably be situated in the lower part of the air starter, being notably formed in the intermediate wall of the casing of the air starter enabling the separation between the first and second compartments.

The first opening can comprise a strainer to protect the turbomachine oil circuit from contamination liable to be generated by the air starter in the receptacle.

The first compartment and the second compartment can advantageously communicate with one another via a second opening for the equilibration of the air pressures between the two compartments.

This second opening can notably be situated in the upper part of the air starter, being notably formed in the intermediate wall of the casing of the air starter enabling the separation between the first and second compartments. This second opening may make it possible to ensure an identical oil level between the AWC of the second compartment and the receptacle of the first compartment, this oil level being regulated by the spout described hereinafter.

The “overrunning” elements of the second compartment can further be enclosed in a bell so as to limit the centrifugal pressure field of the second compartment.

The first and second openings can preferentially be formed in the same intermediate wall of the casing of the air starter defining the first and second compartments.

The second compartment can comprise a spout situated in the AWC type cavity, the spout defining the oil level in the cavity and allowing a return of oil to the turbomachine oil recovery circuit.

In the absence of external leakage, the air starter is further advantageously devoid of a continuous oil flow through the first opening comprising a strainer, situated between the receptacle of the first compartment and the cavity of the second compartment. In the event of oil leakage, an oil flow, supplied by the engine, is established but the flow direction thereof means that the engine is protected from any risk of contamination by the contaminants liable to be contained in the first compartment.

Moreover, the invention also relates, according to a further aspect thereof, to a turbomachine, characterised in that it comprises an air starter as defined above.

The turbomachine can most particularly comprise an accessory gear box AGB, mechanically connected to a rotational drive shaft of the turbomachine. The air starter can be mounted on the AGB, which enables the transmission to the air starter of the pressurised lubrication oil supplied by the turbomachine.

Moreover, the interface between the AGB and the air starter can advantageously be devoid of dynamic tightness. Indeed, the use of an internal AWC type cavity in the air starter makes it possible to withdraw the presence of rotary seals on the connecting shaft of the air starter to the AGB.

The invention further relates, according to a further aspect thereof, a method for oil lubrication of an air starter as defined above, characterised in that it comprises the following steps:
lubrication of the “non-overrunning” elements contained in the first compartment of the air starter by oil splash lubrication,
lubrication of the “overrunning” elements contained in the second compartment of the air starter by conveyance of pressurised oil from the turbomachine oil circuit.

The method according to the invention can comprise any one of the features mentioned above, taken in isolation or according to any technically possible combinations with other features.

### BRIEF DESCRIPTION OF THE FIGURES

The invention can be understood more clearly on reading the detailed description hereinafter, of a non-limiting example of an embodiment thereof, and studying the schematic and partial figures of the appended drawing, wherein:

FIG. 1 illustrates an example of an oil lubrication circuit of an air starter according to the prior art,

FIG. 2 illustrates an example of an air starter according to the invention, suitable for being mounted on an AGB of a turbomachine, and

FIG. 3 represents, in a sectional view, the air starter illustrated schematically in FIG. 2.

Throughout these figures, identical references can denote identical or equivalent elements.

Furthermore, the different parts represented in the figures are not necessarily represented according to a uniform scale, in order to render the figures more legible.

### DETAILED DESCRIPTION OF A PARTICULAR EMBODIMENT

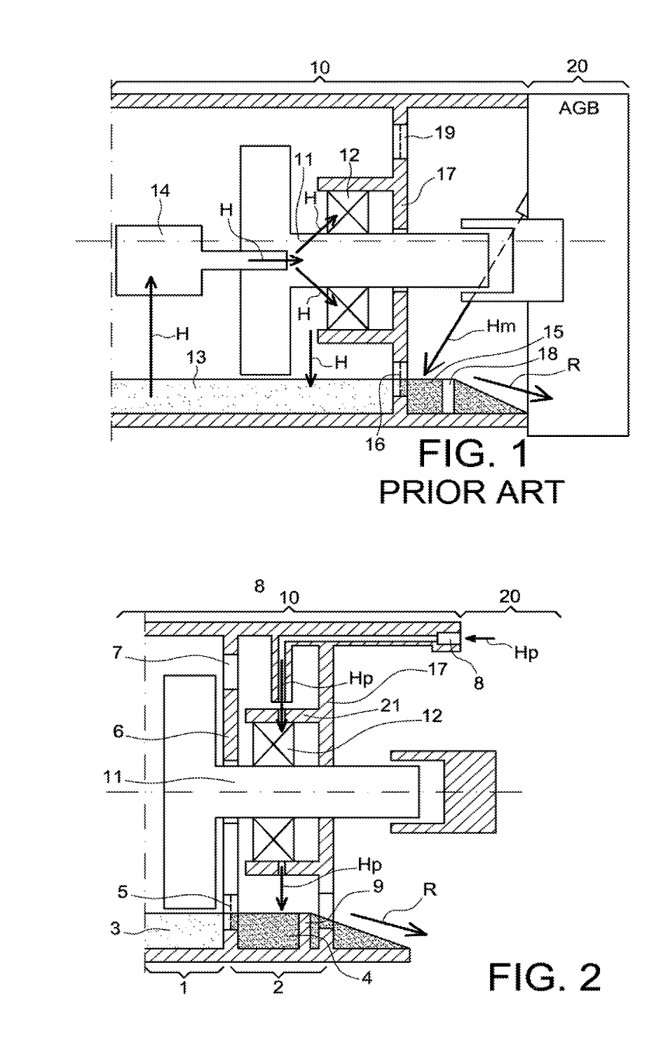

FIG. 1 has previously been described relative to the prior art.

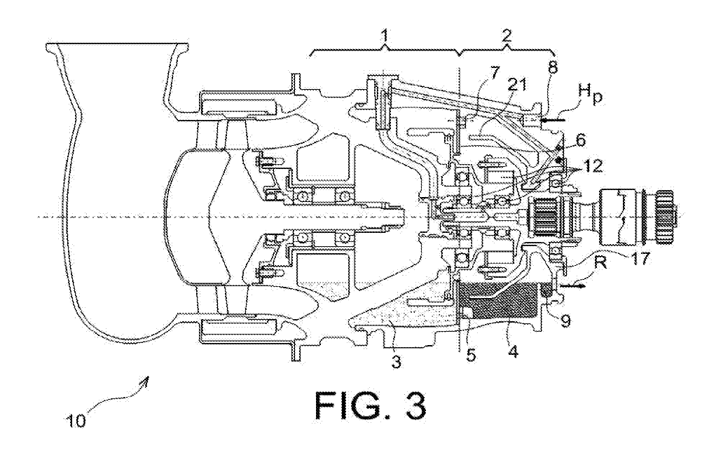

Moreover, with reference to FIGS. 2 and 3, an example of an air starter 10 according to the invention, suitable for being mounted on a turbomachine AGB box 20 has been illustrated.

FIG. 2 is a schematic illustration, similar to that in FIG. 1, of the air starter 10 mounted on the AGB box 20 of an engine, and FIG. 3 represents, in a sectional view, such an air starter 10.

As can be seen in these FIGS. 2 and 3, the air starter 10 comprises a first compartment 1 wherein the “non-overrunning” elements of the air starter 10 are situated, corresponding to the elements which are only run in the engine starting phase. The air starter 10 also includes a second compartment 2 wherein the “overrunning” elements of the air starter 10 are situated, corresponding to the elements suitable for being run in the starting phase of the turbomachine and during the operation of the engine.

Moreover, the first compartment 1 comprises an oil receptacle 3 for oil splash lubrication of the “non-overrunning” elements, and the second compartment 2 comprises an AWC type oil cavity 4 supplied by the lubrication oil return of the “overrunning” elements, in turn supplied under pressure Hp by the engine. The receptacle 3 and the cavity 4 are internal to the air starter 10.

As such, advantageously, the invention proposes to use, in the second compartment 2 of the air starter 10, the pressurised oil Hp supplied by the engine, filtered and at a regulated and monitored temperature, as the source of pressurised lubrication oil Hp of the “overrunning” elements, whereas, in the first compartment 1 of the air starter 10, it proposes to retain an oil splash lubrication bath associated with the AWC 4 supplied by the lubrication oil return of the “overrunning” elements.

Indeed, this design advantageously makes it possible to isolate the “non-overrunning” elements, suitable for making do with oil splash lubrication as they only run during the starting time, and the “overrunning” elements, which require high-quality pressurised lubrication as they run during the starting time and above all also after starting. In this way, it is possible to withdraw the internal oil pump, previously used in solutions according to the prior art, and enhance the quality of the lubrication of the “overrunning” part. This results in a reduction in the cost and mass, and an enhancement of the reliability.

Moreover, two communications are provided between the first compartment 1 and the second compartment 2.

Firstly, the oil receptacle 3 for oil splash lubrication of the first compartment 1 communicates with the AWC type cavity 4 of the second compartment 2 via a first opening 5 enabling the equilibration of the oil levels between the receptacle 3 and the cavity 4. This first opening 5 is situated in the lower part of the air starter 10 and formed in the intermediate wall 6 of the casing of the air starter 10 which marks the separation between the first 1 and second 2 compartments. Advantageously, the first opening is further equipped with a strainer to protect the oil circuit of the engine from contamination liable to be generated by the air starter 10 in the receptacle 3. As such, the overall oil bath of the air starter 10 is separated into two cavities, one forming the receptacle 3 enabling the oil splash lubrication of the “non-overrunning” elements and the other forming the AWC cavity 4 continuously supplied with the return element of the “overrunning” elements, in turn supplied for the lubrication thereof with pressurised oil Hp from the engine.

Moreover, the air pressure between the first 1 and second 2 compartments is kept equal by a vent communication. Indeed, the first compartment 1 and the second compartment 2 advantageously communicate with one another via a second opening 7 for the equilibration of the air pressures between the two compartments. This second opening 7 is situated in the upper part of the air starter 10 and formed in the intermediate wall 6 of the casing of the air starter 10 which marks the separation between the first 1 and second 2 compartments.

Moreover, so as to restrict the effect on the equilibrium of the oil levels of the slight positive pressure generated by the running (or driven) elements in the second compartment 2, these are enclosed in a bell 21.

The oil splash lubrication of the “non-overrunning” elements situated in the first compartment 1 is performed in a manner known per se.

The lubrication of the “overrunning” elements situated in the second compartment 2 is carried out as follows. The engine supplies pressurised oil Hp in a suitable interface 8 of the air starter 10, this oil Hp then being conveyed to the “overrunning” elements which require thorough lubrication. It then flows into the AWC type cavity 4. The second compartment 2 further includes a spout 9, situated in the AWC type cavity 4, which defines the oil level in the cavity 4. In this way, the spout 9, acting as an overflow, can allow an oil return R of the oil discharged into the cavity 4 to the oil recovery circuit of the engine, via an opening formed in the outer wall 17 of the casing of the air starter 10.

Obviously, the invention is not limited to the example of an embodiment described above. Various modifications can be made thereto by those skilled in the art.

The expression “comprising a” should be understood as being synonymous with “comprising at least one”, unless specified otherwise.

1-10. (canceled)

11: A turbomachine air starter comprising:
a first compartment wherein non-overrunning elements of the air starter are situated, corresponding to elements which are only run in a turbomachine starting phase;
a second compartment wherein overrunning elements of the air starter are situated, corresponding to the elements which are run throughout an operating time of the turbomachine, including the starting phase;
the first compartment comprising an oil receptacle for oil splash lubrication of the non-overrunning elements, and the second compartment comprising an AWC type oil cavity for lubrication of the overrunning elements supplied by the lubrication oil return of the overrunning elements, in turn supplied with pressurized lubrication oil supplied by the turbomachine, the receptacle and the cavity being internal to the air starter.

12: An air starter according to claim 11, wherein the oil receptacle for oil splash lubrication of the first compartment communicates with the AWC type oil cavity of the second compartment via a first opening enabling equilibration of oil levels between the receptacle and the cavity.

13: An air starter according to claim 12, wherein the first opening comprises a strainer to protect the turbomachine oil circuit from contamination liable to be generated by the air starter in the receptacle.

14: An air starter according to claim 11, wherein the first compartment and the second compartment communicate with one another via a second opening for equilibration of air pressures between the first and second compartments.

15: An air starter according to claim 11, wherein the overrunning elements of the second compartment are enclosed in a bell to limit a centrifugal pressure field of the second compartment.

16: An air starter according to claim 11, wherein the first and second openings are formed in a same intermediate wall of the casing of the air starter defining the first and second compartments.

17: An air starter according to claim 11, wherein the second compartment comprises a spout situated in the AWC type cavity, the spout defining an oil level in the cavity and allowing a return of oil to the turbomachine oil recovery circuit.

18: A turbomachine comprising an air starter according to claim 11.

19: A turbomachine according to claim 18, comprising an accessory gear box AGB, mechanically connected to a rotational drive shaft of the turbomachine, and wherein the air starter is mounted on the AGB, which enables transmission to the air starter of pressurized lubrication oil supplied by the turbomachine.

20: A method for oil lubrication of an air starter according to claim 11 comprising:
lubrication of the non-overrunning elements contained in the first compartment of the air starter by oil splash lubrication;
lubrication of the overrunning elements contained in the second compartment of the air starter by conveyance of pressurized oil from the turbomachine oil circuit.
